(19) United States
(12) Patent Application Publication
(10) Pub. No.: US 2006/0182286 A1
(43) Pub. Date: Aug. 17, 2006

(54) Support assemblies with tilt adjustment and associated methods

(76) Inventors: Barry Ferrell, Orange, CA (US); Bernie Hawkins, Long Beach, CA (US)

Correspondence Address: PERKINS COIE LLP;PATENT-SEA, P.O. BOX 1247, SEATTLE, WA, 98111-1247, US

(21) Appl. No.: 11/259,421

(22) Filed: Oct. 25, 2005

Related U.S. Application Data
(60) Provisional application No. 60/622,153, filed on Oct. 25, 2004.

(51) Int. Cl. H04R 29/00

(52) U.S. Cl. 381/59; 381/58

(57) ABSTRACT

A speaker aiming system of one embodiment includes a speaker portion that is movable and configured to be aimed in a selected direction. A tilt adjustment device is coupled to the speaker portion. The tilt adjustment device has first and second adjustment portions configured to allow the speaker and the first adjustment portion to be adjustably moved to at least one of a plurality of tilt positions relative to the second adjustment portion. The first adjustment portion has an engagement member releasably coupled to the second adjustment portion to retain the speaker portion in the one of the plurality of tilt positions.

### CROSS REFERENCE TO RELATED APPLICATIONS

This non-provisional patent application claims the benefit of and priority to U.S. Provisional patent application Ser. No. 60/622,153, entitled Support Assemblies with Tilt Adjustment and Associated Methods, filed Oct. 25, 2004, and which is incorporated herein in its entirety by reference thereto.

### TECHNICAL FIELD

Embodiments of the present invention are directed toward support assemblies with tilt adjustment and associated methods, for example, an audio/visual support with tilt adjustment.

### BACKGROUND

Audiovisual components often are placed in selected locations for operation and/or storage. In many cases, it is desirable to orient these components in certain directions and/or to adjust the orientation of the components periodically. For example, it is often desirable to orient speakers so that the sound is directed in a selected direction and/or to orient video displays for viewing from selected locations. Orienting these components in a certain direction can be difficult and time consuming, especially when the components are large and/or located in areas with limited space.

### BRIEF DESCRIPTION OF THE DRAWINGS

FIG. 1 is a partially schematic isometric view of a support system with tilt adjustment used to support a speaker system in accordance with an embodiment of the invention.

FIG. 2 is a side view of the support system shown in FIG. 1.

FIG. 3 is a close-up view of a portion of the support system shown in FIG. 1.

FIG. 4 is a close-up view of a portion of the support system shown in FIG. 1 from a different perspective than that shown in FIG. 3.

FIG. 5 is a close-up view of a portion of the support system shown in FIG. 1 from different perspective than that shown in FIGS. 3 and 4.

### DETAILED DESCRIPTION

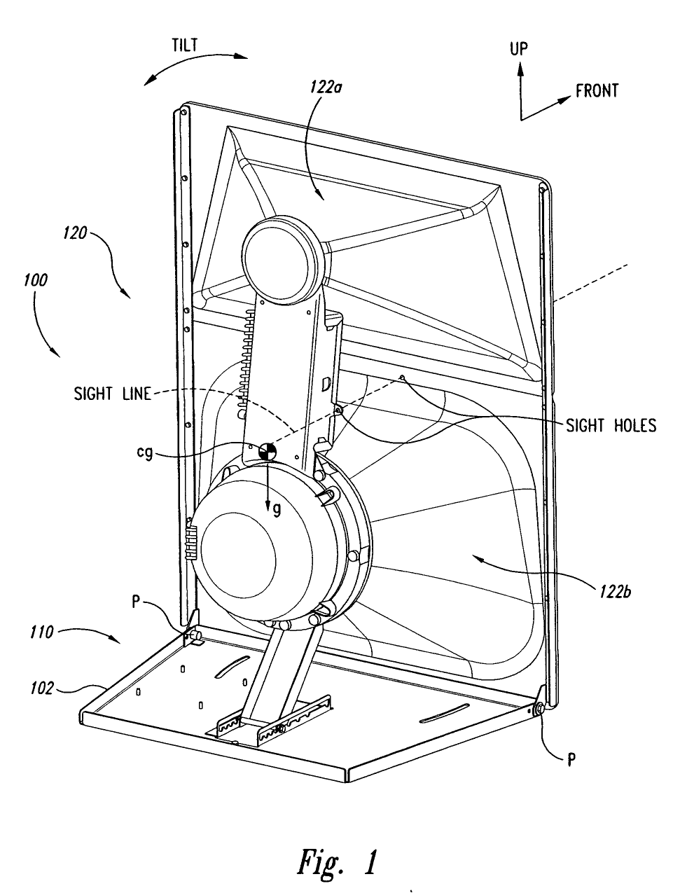

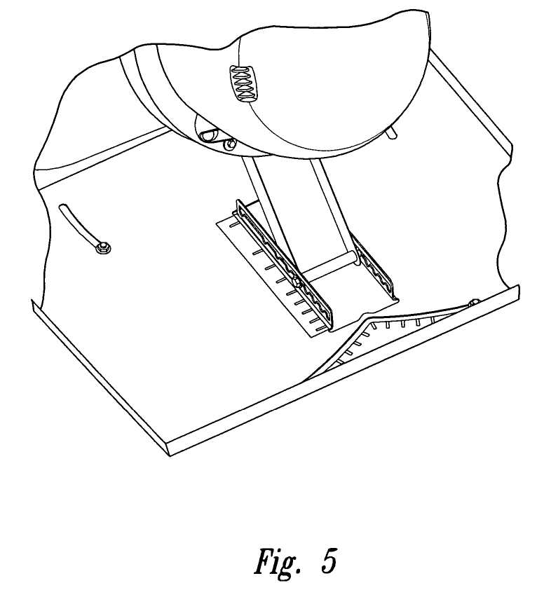

Embodiments of the present invention are directed toward support assemblies with tilt adjustment and associated methods. Several specific details of the invention are set forth in the following description, FIGS. 1-5 to provide a thorough understanding of certain embodiments of the invention. One skilled in the art, however, will understand that the present invention may have additional embodiments, and that other embodiments of the invention may be practiced without several of the specific features described below. For example, the support system assemblies discussed below are discussed with reference to a speaker system and/or other audiovisual components. It will be understood that the support system can be used on any component where having a selectable tilted position is desirable.

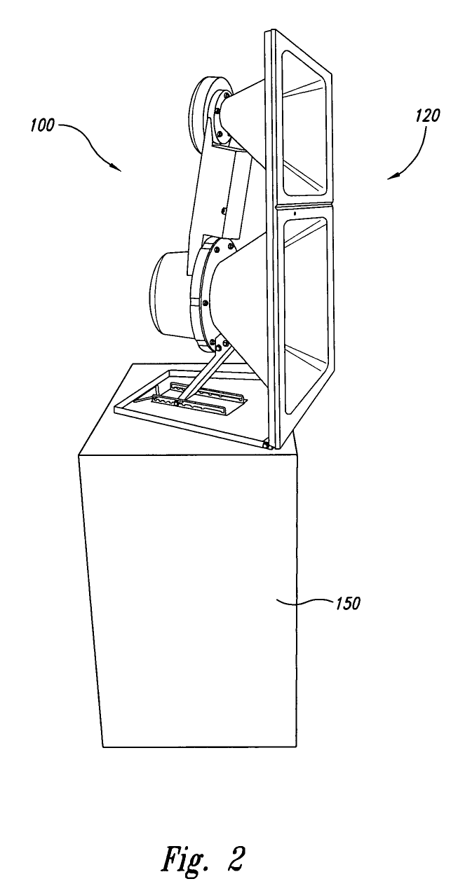

FIG. 1 is a partially schematic illustration of a support system 100 that includes a tilt adjustment device 110. In the illustrated embodiment, the support system 100 is being used to support a speaker system 120, but in other embodiments the support system can be used to support other components (e.g., a video display and/or other audio visual component(s)). The speaker system 120, shown in FIG. 1 includes two speakers 122a and 122b. In other embodiments, the speaker system 120 can include more or fewer speakers and/or be a sub-system (or portion) of a larger speaker system. For example, in FIG. 2 the support system 100 and speaker system 120 (a first speaker system) are positioned on top of a second speaker system 150 and the first speaker system 120 and the second speaker system 150 are both sub-systems of a larger speaker system (e.g., the first speaker system 120 transmits mid and high frequency sound waves and the second speaker system 150 transmits low frequency sound waves). In other embodiments, the support system 100 can support another type of component (e.g., a display and/or other audiovisual component(s)).

Referring back to FIG. 1, the tilt adjustment device 110 includes an engagement member 112 (e.g., a bar) and at least one receiving member 114 (e.g., one or more notches for receiving the engagement member 112). In other embodiments, the tilt adjustment device 110 can have more or fewer engagement members 112 and/or more or fewer receiving members 114. In still other embodiments, the tilt adjustment device 110 can include other arrangements (e.g., an engagement member 112 that includes a pole or bar extending at least partially along a vertical plane that engages one or more receiving members 114 that include upwardly opening hole(s)). In still other embodiments, the support system 100 can include multiple tilt adjustment devices 110.

The tilt adjustment device 110 allows the component being supported to be tilted for various purposes. For example, the tilt adjustment device 110 can be used to aim a speaker system 120 to transmit sound in a selected direction. In other embodiments, the tilt adjustment device 110 can be used to provide a desired viewing angle of a video display device. In still other embodiments, the tilt adjustment device 110 can allow a component to be tilted for storage or transport (e.g., folded to occupy a small space or fit through a small opening).

In the illustrated embodiment, the support system 100 also includes a base 102. The speaker system 120 is pivotally coupled to the base 102 at pivot points P. The speaker system 120 can pivot about pivot points P to tilt forward or aft. Other embodiments can have more or fewer pivot points P. The receiving member 114 is also coupled to the base and configured to receive the engagement member 112 when the speaker system 120 is located in various tilted positions.

In FIG. 1, the engagement member 112 is a bar and the receiving member 114 includes a series of notches for receiving the bar. The speaker system 120 can be tilted relative to the base 102 to a selected position and the bar can be placed into a selected notch (e.g., by moving the bar and/or by slight rotational movement of the speaker system 120). The speaker system 120 can then be released. In the illustrated embodiment, the center of gravity cg of the speaker system 120 is located toward the rear of the speaker system 120 so that the bar is maintained in the notch by the weight of the speaker system 120 (e.g., by gravity g tending to urge an upper portion of the speaker system 120 to rotate toward the tilt adjustment device) even when the front of the speaker system 120 is tilted slightly forward (past vertical).

In other embodiments, the supported component can have a different center of gravity cg placement and the tilt adjustment device 110 can include other arrangements. For example, the center of gravity cg can be located toward a forward portion of a component (e.g., with certain video displays) so that when the front of the component is in a vertical position gravity g tends to cause an upper portion of the component to rotate in a forwardly direction. The tilt adjustment device 110 can be located toward the rear of the component and can include a bar that is urged in a forwardly and upwardly direction as the component tends to rotate forwardly. The tilt adjustment device can also include notches that open in a downwardly direction. The bar can engage at least one of the notches as the component pulls the bar in an upwardly and forwardly direction relative to the downwardly facing notches.

In other embodiments, the tilt adjustment device 110 can be located forward of a component with a forward center of gravity cg and the tilt adjustment device 110 can include a bar that engages notches in a downwardly direction (similar to the notches in FIG. 1). In certain embodiments, the tilt adjustment device 110 can include one or more notches that can be engaged in an upwardly or downwardly direction, and the engagement member 112 must be moved to a mid position relative to the notch(es) before moving the engagement member 112 away from the selected notch. In still other embodiments, the system can include multiple tilt adjustment devices 110 (e.g., one forward of the component and one aft of the component).

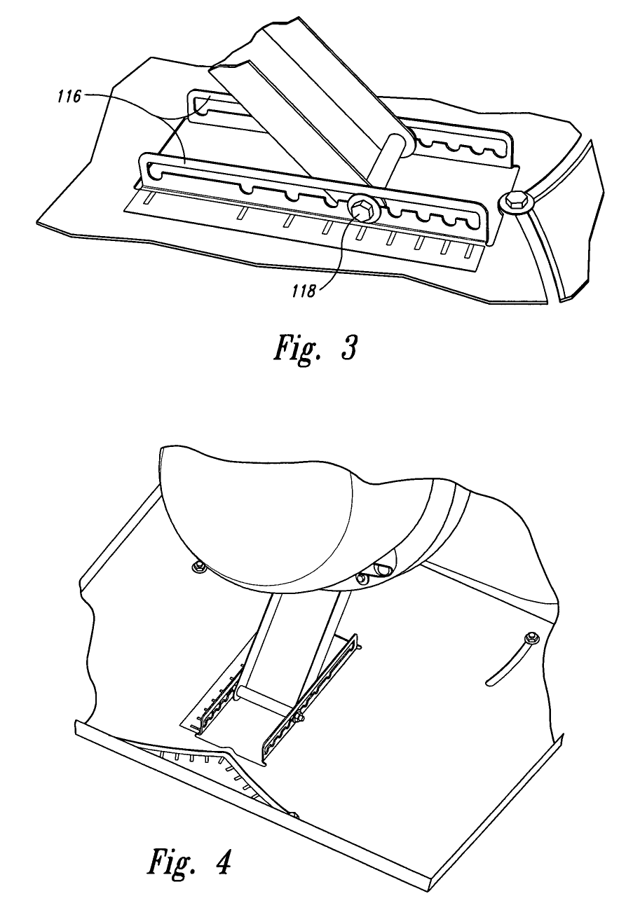

The tilt adjustment device 110 can have one or more selectable positions corresponding to one or more tilted positions of the supported component. As shown in FIGS. 3-5, a scale or index can be provided proximate to and/or on the receiving member 114 to provide a reference for positioning the supported component in a selected position. In other embodiments, the support system 100 does not include a scale or index.

In FIG. 3, a retention member 116 is provided above the notches of the receiving member 114. The retention member 116 insures that the engagement member 112 remains proximate to the receiving member and in certain embodiments the retention member 116 can limit the forward or aft motion of the supported component. In other embodiments, the tilt adjustment device 110 does not include a retention member 116.

In certain embodiments, the tilt adjustment device 110 can include one or more locking mechanisms (e.g., one or more retaining nuts that can resist movement of the engagement member 112 from the engaged position where the engagement member 112 is received by the receiving member 114). For example, in FIG. 3, there is a nut and bolt arrangement that can be tightened against the edges of the notches to aid in retaining the engagement member 112 (e.g., bar) in the receiving member 114 (e.g., notch). Other embodiments can include more or fewer nuts and bolts 118 and/or other types of retention devices, including no retention devices 118.

In certain embodiments, the speaker system 120 is not pivotally coupled to the base 102. In still other embodiments, the support system 100 does not include a base 102, and the speaker system 120 and receiving member 114 are supported by one or more support surfaces (e.g., the ground, a floor, and/or another component). In certain embodiments, in addition to the one or more tilt adjustment devices discussed above, the support system 100 can also include other adjustment devices (e.g., a rotation adjustment device as disclosed in U.S. Provisional Patent Application No. 60/622,109, entitled SUPPORT ASSEMBLIES WITH ROTATION ADJUSTMENT AND ASSOCIATED METHODS, Attorney Docket No. 29671-8011US, which was filed Oct. 25, 2004, and which is hereby incorporated by reference herein in its entirety) and/or other devices (e.g., an aiming device for aiming the speaker system 120 similar to the sight holes and sight line shown in FIG. 1 and as disclosed in U.S. patent application Ser. No. 11/973,649, entitled SPEAKER ASSEMBLY WITH AIMING DEVICE, Attorney Docket No. 29671-8009US, which was filed Oct. 25, 2004, and which is hereby incorporated by reference herein in its entirety).

A feature of embodiments discussed above is that a component supported by a support system can be quickly and easily tilted to a desired position. Additionally, the component can be securely supported in the selected position. An advantage of this feature is that components can be easily and quickly tilted to selected positions to obtain desired performance (e.g., better viewing angles and/or better sound dispersion).

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

I/We claim:

1. A speaker aiming system, comprising:
a speaker portion that is movable and configured to be aimed;
a tilt adjustment device coupled to the speaker portion, the tilt adjustment device having first and second adjustment portions configured to allow the speaker and the first adjustment portion to be adjustably moved to at least one of a plurality of tilt positions relative to the second adjustment portion, the first adjustment portion having an engagement member releasably coupled to the second adjustment portion to retain the speaker portion in the one of the plurality of tilt positions.

2. The speaker aiming system of claim 1, wherein the first adjustment portion is pivotable about a pivot portion, the speaker is aimable at a location forward of the speaker portion, and the speaker and first adjustment portion together have a center of gravity rearward of the pivot portion.

3. The speaker aiming system of claim 1 wherein the second adjustment portion includes a receiving member that releasably received the engagement member and retains the engagement member is one of the plurality of positions.

4. The speaker aiming system of claim 1 wherein the second adjustment portion includes a receiving member that positively engages the engagement member and releasably holds the engagement member is one of the plurality of positions.

5. The speaker aiming system of claim 1 wherein the tilt adjustment device includes indicia coupled to the first adjustment portion corresponding to the plurality of tilt positions.

6. The speaker aiming system of claim 1, wherein the second adjustment portion is a mounting plate mountable to a speaker support structure so the speaker portion is tiltable relative to the speaker support structure.

7. The speaker aiming system of claim 1, wherein the speaker portion is a first speaker portion, and further comprising a second speaker portion coupled to the second adjustment portion, wherein the first speaker portion and the first adjustment portion are movable as a unit relative to the second speaker portion and the second adjustment portion.
